(19) United States
(12) Patent Application Publication
(10) Pub. No.: US 2023/0032681 A1
(43) Pub. Date: Feb. 2, 2023

(54) COIL COMPONENT

(71) Applicant: TDK CORPORATION, Tokyo (JP)

(72) Inventors: Junichiro URABE, Tokyo (JP); Hajime KATO, Tokyo (JP); Toshinori MATSUURA, Tokyo (JP); Kenichi INOUE, Tokyo (JP); Koutarou WATANABE, Tokyo (JP)

(73) Assignee: TDK CORPORATION, Tokyo (JP)

(21) Appl. No.: 17/873,985

(22) Filed: Jul. 26, 2022

(30) Foreign Application Priority Data
Jul. 28, 2021 (JP) 2021-123023

(51) Int. Cl. H01F 27/02; H01F 27/34; H01F 27/28

(52) U.S. Cl. CPC H01F 27/02; H01F 27/34; H01F 27/2823

(57) ABSTRACT

A coil component includes: a base having a pair of side wall portions separated from and facing each other and a connecting wall portion interconnecting the pair of side wall portions; and an air core coil formed by winding a wire, in which the air core coil is disposed in a groove portion formed by the pair of side wall portions and the connecting wall portion.

### CROSS REFERENCE TO RELATED APPLICATIONS

This application claims priority to Japanese Patent Application No. 2021-123023 filed on Jul. 28, 2021, the entire contents of which are incorporated by reference herein.

### TECHNICAL FIELD

One aspect of the present disclosure relates to a coil component.

### BACKGROUND

A coil component of the related art is described in Japanese Unexamined Patent Publication No. H9-260161. In this coil component, in order to reduce the stray capacitance generated between wound wires, a single-layer winding part is formed in a partial region and a self-resonant frequency (SRF) at a high frequency is ensured.

In the coil component described above, a winding core is disposed on the inner peripheral side of a coil. Accordingly, a problem arises as the effect of the dielectric constant of the winding core causes a decline in the resonance frequency of the coil. Accordingly, it has been required to suppress a decline in the resonance frequency of the coil.

### SUMMARY

An object of one aspect of the present disclosure is to provide a coil component capable of suppressing a decline in the resonance frequency of a coil.

A coil component according to one aspect of the present disclosure includes: a base having a pair of side wall portions separated from and facing each other and a connecting wall portion interconnecting the pair of side wall portions; and an air core coil formed by winding a wire, in which the air core coil is disposed in a groove portion formed by the pair of side wall portions and the connecting wall portion.

In the coil component, the air core coil formed by winding the wire is used as a coil. The air core coil is capable of suppressing the effect of the dielectric constant of a winding core unlike a coil that has an inner peripheral side where a winding core is disposed. The air core coil is disposed in the groove portion of the base formed by the pair of side wall portions and the connecting wall portion. Accordingly, the coil component supports the winding core-less air core coil with the base from the outer peripheral side of the air core coil. In other words, the base is capable of supporting the air core coil while suppressing the effect of the dielectric constant on the inner peripheral side of the air core coil. As a result of the above, a decline in the resonance frequency of the coil can be suppressed.

A resin may be disposed in a gap between an inner surface of the groove portion and the air core coil. In this case, the resin is capable of adhesion between the base and the air core coil. Accordingly, the strength and reliability of the coil component can be improved by suppressing a movement of the air core coil and stabilizing the air core coil.

A resin filling the air core coil may be disposed in the groove portion. In this case, the resin is capable of adhesion between the base and the air core coil. Further, the resin is capable of supporting the air core coil from the inside. Accordingly, the strength and reliability of the coil component can be improved by suppressing a movement of the air core coil and stabilizing the air core coil.

The pair of side wall portions may have a mounting surface in an end portion on a side opposite to the connecting wall portion, a step portion positioned closer to the connecting wall portion side than another part may be formed in the mounting surface, and a pull-out portion of the air core coil may be connected to the step portion. In this case, protrusion of the pull-out portion from the mounting surface can be suppressed by the step portion accommodating the pull-out portion of the air core coil. Accordingly, the stability of mounting on the mounting surface of the coil component can be improved.

According to one aspect of the present disclosure, a coil component capable of suppressing a decline in the resonance frequency of a coil can be provided.

### BRIEF DESCRIPTION OF THE DRAWINGS

FIG. 1 is a perspective view of a coil component according to an embodiment of the present disclosure.

FIG. 2 is a perspective view of a coil component according to a modification example.

FIG. 3 is a front view of the coil component according to the modification example.

FIG. 4 is a front view of a coil component according to a modification example.

FIG. 5 is a perspective view of a coil component according to a modification example.

### DETAILED DESCRIPTION

Hereinafter, an embodiment will be described in detail with reference to the accompanying drawings. In the description, the same reference numerals will be used, with redundant description omitted, for the same or functionally identical elements.

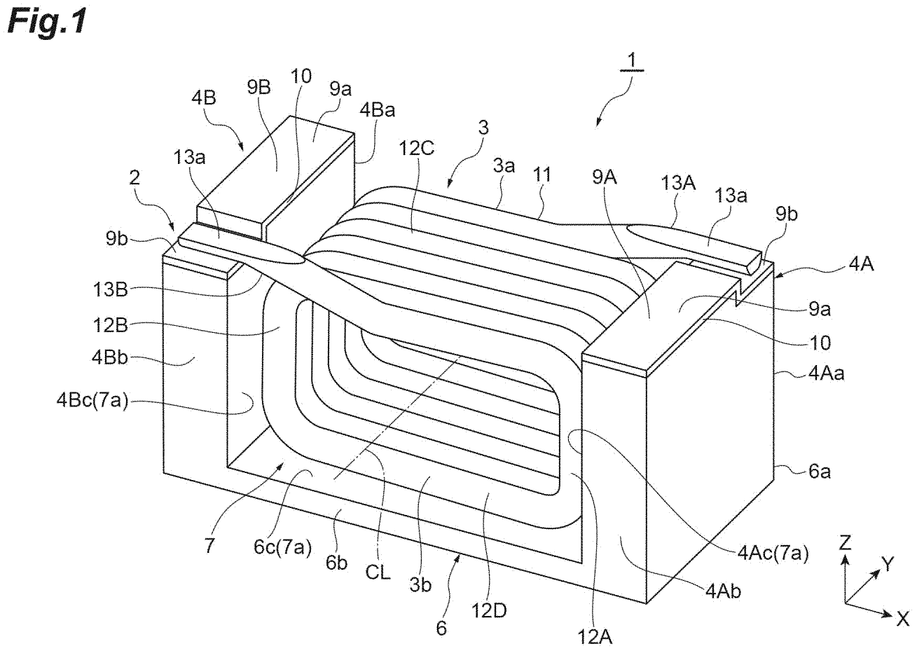

FIG. 1 is a perspective view of a coil component 1 according to the embodiment of the present disclosure. As illustrated in FIG. 1, the coil component 1 includes a base 2 and an air core coil 3. Here, in the following description, the configuration of each component may be described using XYZ coordinates that are relative coordinates set with respect to the coil component 1. The Y-axis direction is orthogonal to the X-axis direction. The Z-axis direction is orthogonal to the X-axis direction and the Y-axis direction. In addition, one side in the X-axis direction, the Y-axis direction, and the Z-axis direction is referred to as a “positive side” and the other side is referred to as a “negative side”. In the drawings, an arrow is pointed from the negative side toward the positive side on each axis.

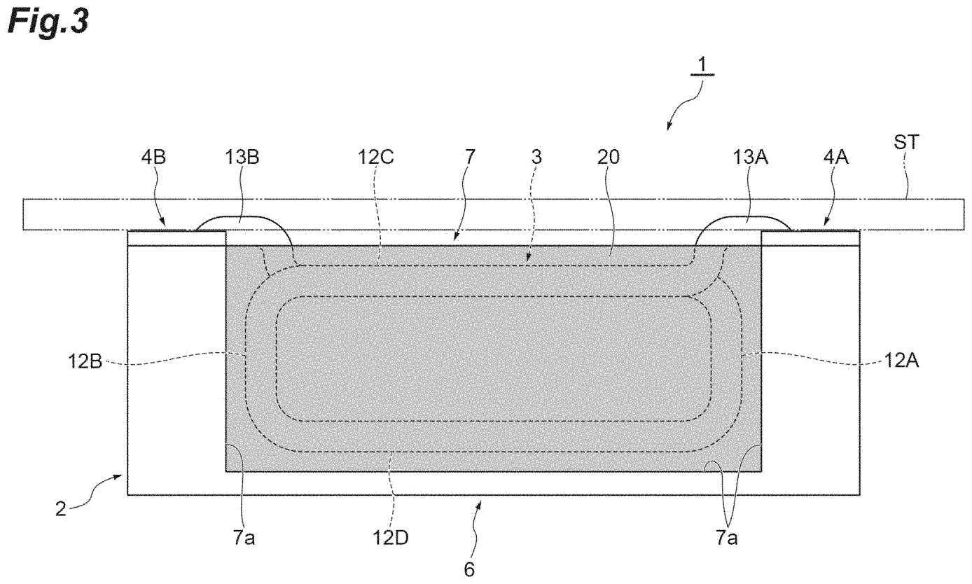

The base 2 is a member holding the air core coil 3. The base 2 is a member mounted on another circuit board (for example, a substrate ST in FIG. 3) together with the air core coil 3. The base 2 has a pair of side wall portions 4A and 4B and a connecting wall portion 6.

The pair of side wall portions 4A and 4B are rectangular wall portions extending in parallel to the YZ plane. In addition, the side wall portions 4A and 4B are separated from each other in the X-axis direction and face each other so as to be parallel to each other. The connecting wall portion 6 is a wall portion interconnecting the side wall portions 4A and 4B. The connecting wall portion 6 interconnects the end portions of the side wall portions 4A and 4B on the negative side in the Z-axis direction. The connecting wall portion 6 is a rectangular wall portion extending in parallel to the XY plane between the side wall portions 4A and 4B.

On the positive side of the base 2 in the Y-axis direction, an end surface 4Aa of the side wall portion 4A, an end surface 4Ba of the side wall portion 4B, and an end surface 6a of the connecting wall portion 6 form the same plane by being disposed at the same position in the Y-axis direction. On the negative side of the base 2 in the Y-axis direction, an end surface 4Ab of the side wall portion 4A, an end surface 4Bb of the side wall portion 4B, and an end surface 6b of the connecting wall portion 6 form the same plane by being disposed at the same position in the Y-axis direction.

The side wall portions 4A and 4B have mounting surfaces 9A and 9B in the end portions thereof on the positive side in the Z-axis direction, which is the side opposite to the connecting wall portion 6. The mounting surface 9A and the mounting surface 9B are formed at the same height position in the Z-axis direction. The mounting surfaces 9A and 9B have electrode layers 10. The electrode layers 10 are configured at the resin parts of the side wall portions 4A and 4B by covering the entire surfaces of the end surfaces on the positive side in the Z-axis direction. The electrode layers 10 may be partially formed on the mounting surfaces 9A and 9B depending on the aspect of connection to the air core coil 3 and the circuit board. The electrode layer 10 includes, for example, a resin electrode. The electrode layer 10 may be formed from, for example, only a resin electrode. The electrode layer 10 is formed by a known technique. For example, the electrode layer 10 is formed by electrode paste being applied to the base 2 and then dried. The electrode paste is applied to the base 2 by, for example, a screen printing method. The electrode layer 10 is plated. Further detailed configurations of the mounting surfaces 9A and 9B will be described later together with the description of the air core coil 3.

The base 2 has a groove portion 7 formed by the side wall portions 4A and 4B and the connecting wall portion 6. The groove portion 7 is configured by a side surface 4Ac of the side wall portion 4A on the negative side in the Y-axis direction, a side surface 4Bc of the side wall portion 4B on the positive side in the Y-axis direction, and a main surface 6c of the connecting wall portion 6 on the positive side in the Z-axis direction. An inner surface 7a of the groove portion 7 is configured by the side surfaces 4Ac and 4Bc and the main surface 6c. The groove portion 7 is open on the positive side in the Y-axis direction, the negative side in the Y-axis direction, and the positive side in the Z-axis direction. By having the groove portion 7, the base 2 is U-shaped when viewed from the Y-axis direction. In addition, the base 2 configures a recess recessed in the groove portion 7 when viewed from the Y-axis direction.

The base 2 contains resin. The base 2 is, for example, made of resin. The resin material that forms the base 2 contains, for example, at least one selected from phenol resin, liquid crystal polymer, polyimide resin, crystalline polystyrene, epoxy resin, bismaleimide resin, and fluororesin.

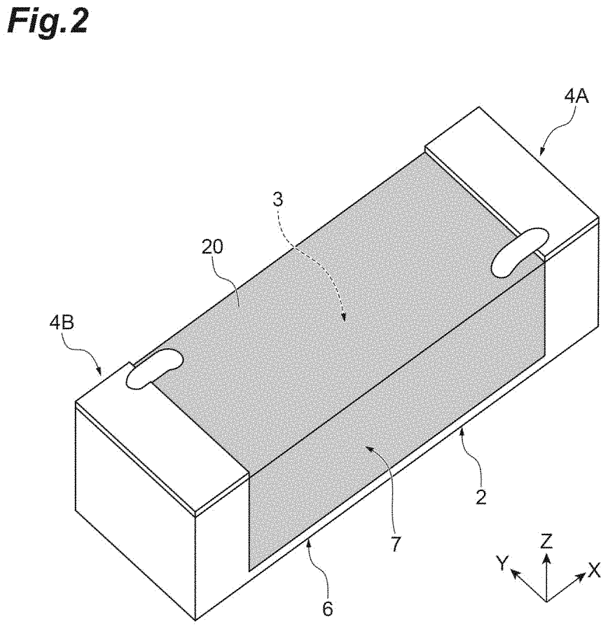

The air core coil 3 is a component formed by winding a wire 11. The air core coil 3 is formed by winding the wire 11 around a winding core at the time of manufacturing. However, the winding core is pulled out after the wire 11 is wound, and thus the winding core around which the wire 11 is wound does not exist in the region on the inner peripheral side of the air core coil 3 in the finished product state of the coil component 1. In the present embodiment, no solid is disposed in the region on the inner peripheral side of the air core coil 3 and the region is an empty space. In a case where a solid is disposed in the region on the inner peripheral side of the air core coil 3 (such as the case of FIG. 2 to be described later), the dielectric constant of the solid is preferably 4 or less and more preferably 3 or less.

The wire 11 is not particularly limited insofar as it is a conductor wire capable of forming the air core coil 3. The diameter of the wire 11 is appropriately changed depending on the size of the air core coil 3 and may be set to 0.02 to 0.04 mm. The material of the wire 11 is not particularly limited and contains, for example, at least one selected from gold, nickel, tin, silver, copper, and aluminum.

The air core coil 3 is disposed in the groove portion 7 of the base 2. The air core coil 3 is disposed such that a winding axis CL extends in parallel to the Y-axis direction. In other words, the air core coil 3 is disposed in the groove portion 7 in a state where the winding axis CL is orthogonal to the facing direction of the side wall portions 4A and 4B and is parallel to the connecting wall portion 6.

In the present embodiment, the air core coil 3 has a rectangular coil shape when viewed from the Y-axis direction, that is, the axial direction. The air core coil 3 has peripheral wall portions 12A, 12B, 12C, and 12D. The peripheral wall portion 12A extends in parallel to the ZY plane at a position on the positive side in the X-axis direction. The peripheral wall portion 12B extends in parallel to the ZY plane at a position on the negative side in the X-axis direction. The peripheral wall portion 12C extends in parallel to the XY plane at a position on the positive side in the Z-axis direction. The peripheral wall portion 12D extends in parallel to the XY plane at a position on the negative side in the Z-axis direction.

The peripheral wall portion 12A faces the side surface 4Ac of the side wall portion 4A at a position separated in the X-axis direction in the groove portion 7. The peripheral wall portion 12B faces the side surface 4Bc of the side wall portion 4B at a position separated in the X-axis direction in the groove portion 7. The peripheral wall portion 12C is disposed at a position closer to the negative side in the Z-axis direction than the mounting surfaces 9A and 9B. The peripheral wall portion 12D faces the main surface 6c of the connecting wall portion 6 at a position separated in the Z-axis direction in the groove portion 7. In addition, an end portion 3a of the air core coil 3 on the positive side in the Y-axis direction is disposed closer to the negative side in the Y-axis direction than the end surfaces 4Aa, 4Ba, and 6a of the base 2. An end portion 3b of the air core coil 3 on the negative side in the Y-axis direction is disposed closer to the positive side in the Y-axis direction than the end surfaces 4Ab, 4Bb, and 6b of the base 2. The size of the gap between the inner surface 7a of the groove portion 7 and each peripheral wall portion of the air core coil 3 is not particularly limited and may be set to 0.005 to 0.010 mm Each part of the air core coil 3 may also be disposed inside the groove portion 7 at a distance of approximately 0.005 to 0.010 mm from the opening portion of the groove portion 7.

The air core coil 3 has a pair of pull-out portions 13A and 13B. The pull-out portion 13A is a part connected to the electrode layer 10 of the mounting surface 9A. The pull-out portion 13B is a part connected to the electrode layer 10 of the mounting surface 9B. Both the pull-out portion 13A and the pull-out portion 13B are pulled out from the position of the peripheral wall portion 12C in the air core coil 3. The pull-out portion 13A is pulled out from the end portion 3a of the air core coil 3 on the positive side in the Y-axis direction toward the positive side in the X-axis direction. The pull-out portion 13B is pulled out from the end portion 3b of the air core coil 3 on the negative side in the Y-axis direction toward the negative side in the X-axis direction. The pull-out portions 13A and 13B are connected to the mounting surfaces 9A and 9B by a method such as soldering and ultrasonic crimping.

Formed in the mounting surfaces 9A and 9B are step portions 9b positioned closer to the connecting wall portion 6 side, that is, the negative side in the Z-axis direction than a general portion 9a (another part). The pull-out portion 13A is connected to the step portion 9b of the mounting surface 9A. The pull-out portion 13B is connected to the step portion 9b of the mounting surface 9B. In the mounting surface 9A, the step portion 9b is formed in the end portion on the positive side in the Y-axis direction. In the mounting surface 9B, the step portion 9b is formed in the end portion on the negative side in the Y-axis direction. The difference in height between the general portion 9a and the step portion 9b is not particularly limited, and the difference is preferably within a range in which the connected pull-out portions 13A and 13B do not protrude from the general portion 9a. In a case where the pull-out portions 13A and 13B are crushed to form a crushed surface 13a due to the pressure at the time of connection, it is preferable that the crushed surface 13a does not protrude from the general portion 9a.

Next, a method for manufacturing the coil component 1 will be described. First, a winding core is prepared and the wire 11 is wound around the winding core. When the winding of the wire 11 is completed, the winding core is removed from the winding body. As a result, the air core coil 3 is obtained. Next, the air core coil 3 is disposed in the groove portion 7 of the base 2. Next, the pull-out portion 13A is connected to the mounting surface 9A of the base 2, and the pull-out portion 13B is connected to the mounting surface 9B of the base 2. Next, the coating of the wire 11 is peeled off. Then, an electrode material is applied to the joining parts of the pull-out portions 13A and 13B. The coil component 1 is completed as a result of the above.

Next, the action and effect of the coil component 1 according to the present embodiment will be described.

In the coil component 1, the air core coil 3 formed by winding the wire 11 is used as a coil. The air core coil 3 is capable of suppressing the effect of the dielectric constant of a winding core unlike a coil that has an inner peripheral side where a winding core is disposed. In other words, in the air core coil 3, stray capacitance can be generated between the adjacent wires 11 in each of the peripheral wall portions 12A, 12B, 12C, and 12D. In addition, when viewed from the Y-axis direction, stray capacitance can be generated between the wire 11 of the peripheral wall portion 12A and the wire 11 of the peripheral wall portion 12B. In addition, stray capacitance can be generated between the wire 11 of the peripheral wall portion 12C and the wire 11 of the peripheral wall portion 12D. With respect to such an aspect of stray capacitance generation, the air core coil 3 has no high-dielectric constant winding on the inner peripheral side, and thus the effect of inter-wire stray capacitance can be suppressed.

The air core coil 3 is disposed in the groove portion 7 of the base 2 formed by the pair of side wall portions 4A and 4B and the connecting wall portion 6. Accordingly, the coil component 1 supports the winding core-less air core coil 3 with the base 2 from the outer peripheral side of the air core coil 3. In other words, the base 2 is capable of supporting the air core coil 3 while suppressing the effect of the dielectric constant on the inner peripheral side of the air core coil 3. As a result of the above, a decline in the resonance frequency of the coil can be suppressed.

In addition, the base 2 has the connecting wall portion 6 connecting the side wall portions 4A and 4B in addition to the side wall portions 4A and 4B supporting the air core coil 3. Accordingly, the coil component 1 can be automatically grasped by a robot or the like at the time of mounting or the like.

The pair of side wall portions 4A and 4B have mounting surfaces 9A and 9B in the end portions on the side opposite to the connecting wall portion 6, the step portions 9b positioned closer to the connecting wall portion 6 side than the general portion 9a are formed in the mounting surfaces 9A and 9B, and the pull-out portions 13A and 13B of the air core coil 3 may be connected to the step portions 9b. In this case, protrusion of the pull-out portions 13A and 13B from the mounting surfaces 9A and 9B can be suppressed by the step portions 9b accommodating the pull-out portions 13A and 13B of the air core coil 3. Accordingly, the stability of mounting on the mounting surfaces 9A and 9B of the coil component 1 can be improved.

The present disclosure is not limited to the embodiment described above.

For example, as illustrated in FIGS. 2 and 3, a resin 20 that fills the air core coil 3 may be disposed in the groove portion 7. The entire internal space of the groove portion 7 is filled with the resin 20. Accordingly, in the groove portion 7, the entire air core coil 3 except for the pull-out portions 13A and 13B is filled with the resin 20.

As illustrated in FIG. 3, the resin 20 is disposed in the gap between the air core coil 3 and the inner surface 7a of the groove portion 7. The resin 20 is capable of adhesion between the base and the air core coil. Specifically, the resin 20 is capable of adhesion between the peripheral wall portion 12A and the side wall portion 4A, between the peripheral wall portion 12B and the side wall portion 4B, and between the peripheral wall portion 12D and the connecting wall portion 6.

Further, the resin 20 is capable of supporting the air core coil 3 from the inside. In other words, the region on the inner peripheral side surrounded by the peripheral wall portions 12A, 12B, 12C, and 12D is also supported by the resin 20. Accordingly, the strength and reliability of the coil component 1 can be improved by suppressing a movement of the air core coil 3 and stabilizing the air core coil 3.

The resin 20 disposed on the inner peripheral side of the air core coil 3 does not have a function as a winding core, and thus the coil in the resin 20 functions as an air core coil. Preferably, the dielectric constant of the resin 20 is at least lower than the dielectric constant of the material of the base 2 and lower than the dielectric constant of the coating of the wire 11.

The material of the resin 20 contains, for example, at least one selected from liquid crystal polymer, polyimide resin, crystalline polystyrene, epoxy resin, and fluororesin. The polyimide resin contains, for example, bismaleimide resin. The fluororesin contains, for example, polytetrafluoroethylene (PTFE) resin.

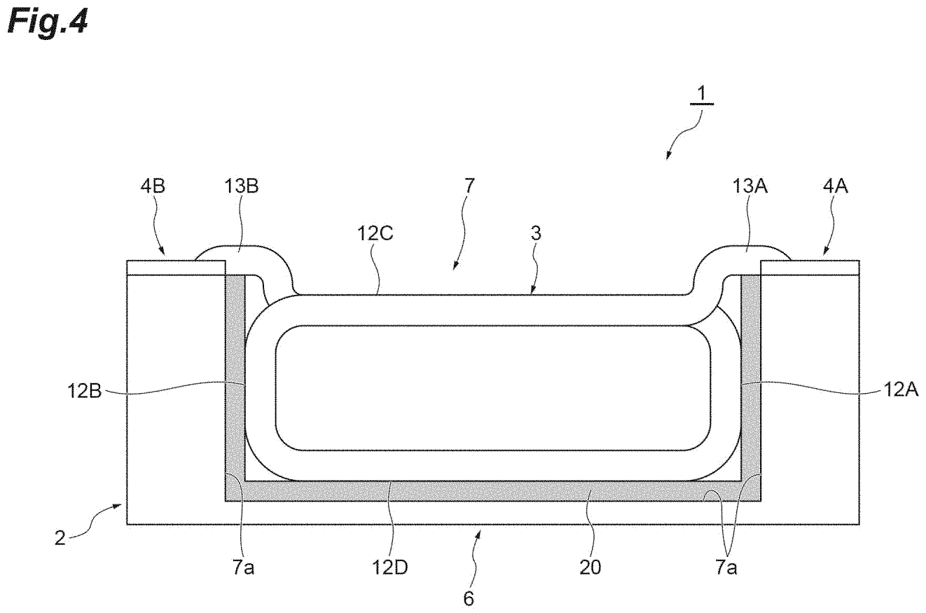

In addition, as illustrated in FIG. 4, the resin 20 may be disposed only in the gap between the inner surface 7a of the groove portion 7 and the air core coil 3. In this case, the resin 20 is capable of adhesion between the base 2 and the air core coil 3. Accordingly, the strength and reliability of the coil component 1 can be improved by suppressing a movement of the air core coil 3 and stabilizing the air core coil 3.

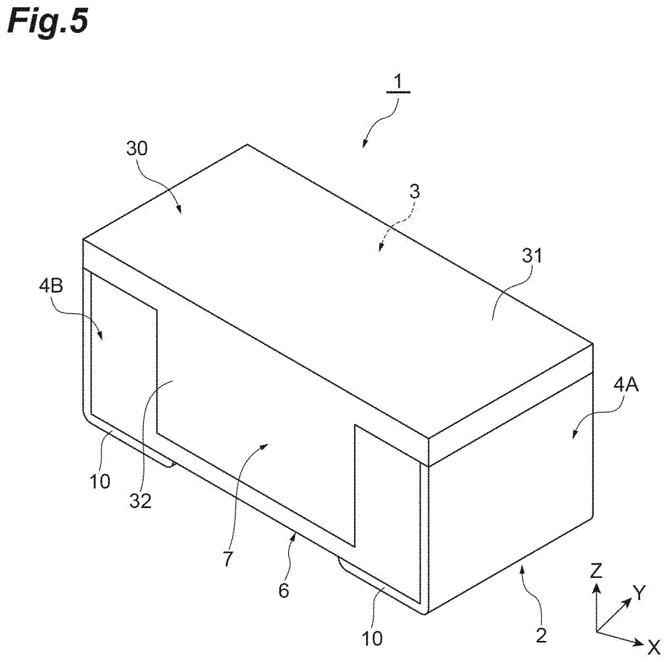

In addition, as illustrated in FIG. 5, a cover member 30 blocking an opening portion may be provided with respect to the groove portion 7 of the base 2. The cover member 30 includes a top plate 31 blocking the opening portion of the groove portion 7 on the positive side in the Z-axis direction and a wall plate 32 blocking the opening portion of the groove portion 7 in the Y-axis direction. In a case where the mounting surfaces 9A and 9B are blocked by the top plate 31, the electrode layer 10 may be extended to the surface of the connecting wall portion 6 on the negative side in the Z-axis direction for the surface of the connecting wall portion 6 to serve as a mounting surface.

Although a rectangular air core coil has been exemplified in the embodiment described above, the coil shape is not particularly limited. For example, a circular, oval, elliptical, or polygonal coil shape may be adopted. In addition, the number of turns of the coil is not limited to that illustrated in FIG. 1. In addition, the dimensions of the coil can be changed as appropriate.

1. A coil component comprising:

a base including a pair of side wall portions separated from and facing each other and a connecting wall portion interconnecting the pair of side wall portions; and

an air core coil formed by winding a wire,

wherein the air core coil is disposed in a groove portion formed by the pair of side wall portions and the connecting wall portion.

2. The coil component according to embodiment 1, wherein a resin is disposed in a gap between an inner surface of the groove portion and the air core coil.
3. The coil component according to embodiment 1 or 2, wherein a resin filling the air core coil is disposed in the groove portion.
4. The coil component according to any one of embodiment 1 to 3, wherein

the pair of side wall portions have a mounting surface in an end portion on a side opposite to the connecting wall portion,

a step portion positioned closer to the connecting wall portion side than another part is formed in the mounting surface, and

a pull-out portion of the air core coil is connected to the step portion.

### REFERENCE SIGNS LIST

1: coil component, 2: base, 3: air core coil, 4A, 4B: side wall portion, 6: connecting wall portion, 7: groove portion, 9A, 9B: mounting surface, 9b: step portion, 11: wire, 13A, 13B: pull-out portion, 20: resin.

What is claimed is:

1. A coil component comprising:
a base including a pair of side wall portions separated from and facing each other and a connecting wall portion interconnecting the pair of side wall portions; and
an air core coil formed by winding a wire,
wherein the air core coil is disposed in a groove portion formed by the pair of side wall portions and the connecting wall portion.

2. The coil component according to claim 1, wherein a resin is disposed in a gap between an inner surface of the groove portion and the air core coil.

3. The coil component according to claim 1, wherein a resin filling the air core coil is disposed in the groove portion.

4. The coil component according to claim 1, wherein
the pair of side wall portions have a mounting surface in an end portion on a side opposite to the connecting wall portion,
a step portion positioned closer to the connecting wall portion side than another part is formed in the mounting surface, and
a pull-out portion of the air core coil is connected to the step portion.
